(19) United States
(12) Patent Application Publication
(10) Pub. No.: US 2012/0243980 A1
(43) Pub. Date: Sep. 27, 2012

(54) Rotatable Dry Air Supply

(75) Inventors: Leigh Zalusky, Vacaville, CA (US); Thomas Jay Green, Roseville, CA (US)

(73) Assignee: Frontier Wind, LLC, West Conshohocken, PA (US)

(21) Appl. No.: 13/071,673

(22) Filed: Mar. 25, 2011

(51) Int. Cl. F03D 11/00; B01D 53/02; B01D 53/26; F03D 11/04

(52) U.S. Cl. 415/182.1; 416/244 A; 96/118

(57) ABSTRACT

A rotatable dry air supply system for a wind turbine is provided. The system includes a rotatable dry air supply housing connected to a rotatable hub having a plurality of wind turbine blades connected thereto. The housing is rotatable with the hub and includes a compressor and a moisture trap for removing moisture from the compressed air. The moisture trap may include a plurality of outlet ports arranged around a casing of the moisture trap. The moisture purged from the outlet ports may exit through a moisture outlet in the housing of the rotatable air supply. In some arrangements, the outlet may be heated.

### TECHNICAL FIELD

The invention relates generally a rotatable dry air supply for purging one or more ports on a wing or blade.

### BACKGROUND

Wind turbines rely on aerodynamic lift to turn a rotor and generate electricity. In order to control the aerodynamic lift and optimize performance of various airfoils (e.g., wind turbine blades), it would be beneficial to quickly and easily determine the lift generated by the airfoil. Accordingly, various pressure sensors are positioned along a length of one or more turbine blades. The pressure sensors may be contained within ports along the blades. However, moisture (e.g., ice) and other debris, dirt, etc. may accumulate in the ports. In order to maintain the accuracy of the pressure sensors within the ports, the ports may be purged periodically to remove any moisture, debris, etc. This purging process often uses high pressure, dry air in order to avoid the introduction of additional moisture to the ports.

Conventional dry air supply systems rely on gravity to drain moisture from the compressed air stream. However, this arrangement prevents the dry air supply from being rotatable with the wind turbine blades because moisture will accumulate in points in the rotation of the turbine blades in which the moisture outlet is not aligned with gravity. This may limit the times in the rotation when dry air can be used to purge ports and/or the placement and configuration of the dry air supply system. In some conventional arrangements, the turbine blades may be stopped in order to purge the ports. This is inefficient and time consuming. Accordingly, a system of providing a rotatable dry air supply would be advantageous.

### BRIEF SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the conventional systems described above, and to overcome other limitations that will be apparent upon reading and understanding the present specification, aspects of the disclosure are directed to a system for providing a dry air supply that is rotatable with a blade assembly in order to provide high pressure air for purging one or more ports arranged along a blade.

In at least some aspects, the rotatable dry air supply may be connected to a hub of a blade assembly. Accordingly, the dry air supply may rotate with the hub and, thus the blades connected to the hub. This rotation of the dry air supply provides a continuous supply of dry air for use in purging one or more pressure sensing or other types of ports along a length of the blade.

The rotatable dry air supply may include various components for removing moisture from the compressed air stream, such as a moisture separator, dryer and moisture trap. In some examples, the moisture trap may include a plurality of moisture trap outlets configured to allow removal of moisture that has accumulated in the moisture trap casing to exit the moisture trap. The moisture trap outlets may be arranged around the casing and, in some examples, may be arranged around the casing in order to provide an outlet for moisture throughout the entire rotation of the hub and, correspondingly, the entire rotation of the dry air supply. In some examples, the moisture trap outlets may be arranged equidistant around the casing.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a side view of a wind turbine according to at least some aspects of the present disclosure.

FIG. 2 is a side view of an upper portion of a wind turbine illustrating a rotatable dry air supply according to at least some aspects of the present disclosure.

FIG. 3 is a perspective view of a dry air supply system according to at least some aspects of the present disclosure.

FIG. 4 is a side view of the dry air supply system of FIG. 3 having a moisture trap according to one or more aspects of the present disclosure.

FIG. 5A is a side view of the moisture trap of FIG. 4 shown in isolation according to one or more aspects of the present disclosure.

FIG. 5B is an exploded view of the moisture trap of FIG. 5A according to one or more aspects of the present disclosure.

FIG. 6A is a perspective view of a rotatable dry air supply with a portion of a casing attached and having a moisture trap and moisture outlet according to one or more aspects of the present disclosure.

FIG. 6B is a side view of the rotatable dry air supply of FIG. 6A with the portion of the casing removed and illustrating the moisture outlet in an inset according to one or more aspects of the present disclosure.

FIG. 6C is a perspective view of the moisture outlet of FIGS. 6A and 6B shown in isolation according to one or more aspects of the present disclosure.

FIG. 7 is a schematic diagram of the dry air supply system according to one or more aspects of the present disclosure.

The reader is advised that the figures are not necessarily drawn to scale.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Aspects of the present invention are directed to a system of providing dry air to purge one or more ports or orifices arranged on a wing, blade, etc., such as a blade of a wind turbine. For instance, one or more ports or orifices are often arranged on an airfoil, such as a wind turbine blade, in order to measure pressure or other environmental, air flow, etc. characteristics at various points along the blade. These measurements may be used to aid in operation, optimization, etc. of the wind turbine such as for power generation. However, as the ports may become clogged with moisture (e.g., ice, etc.), debris, dirt, etc., the ports are purged to remove the blockages. This purging may be performed with dry air in order to reduce the introduction of additional moisture to the port. Aspects may include a dry air supply that is rotatable with the blades of the turbine in order to provide dry purge air continuously during operation of the turbine. For example, the dry air supply may be disposed within a rotor blade or within a hub of the turbine. Additionally or alternatively, the rotatable dry air supply may be connected to a hub (e.g., positioned on a rear of the hub) as will be discussed more fully below.

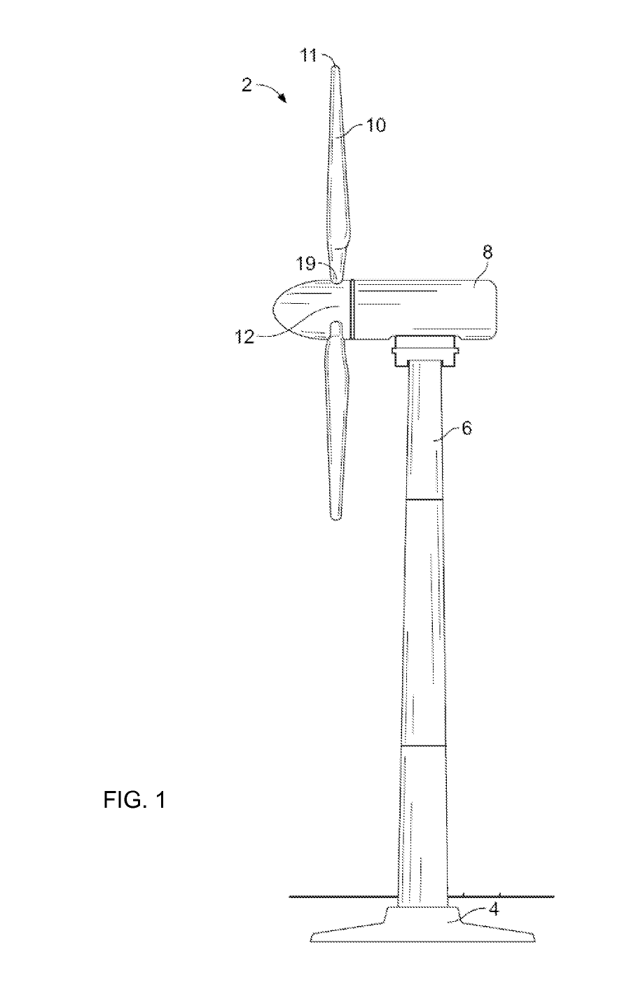

FIG. 1 shows an example wind turbine 2 with which the present invention may be implemented. The wind turbine 2 is shown on a foundation 4 with a tower 6 supporting a nacelle 8. One or more blades 10 are attached to a hub 12. In some examples, the blades 10 may be connected to the hub 12 via a bolt flange (not shown in FIG. 1). In the depicted arrangement, the wind turbine 2 includes three blades 10. However, more or fewer blades 10 may be used without departing from the invention. The hub 12 is connected to a gear box, a generator, and other components within the nacelle 8. The blades 10 may have a fixed length or may be of the variable length-type, e.g., telescopic. As shown in FIG. 1, each blade 10 includes a root or base portion 19 and a tip portion 11. In arrangements having a variable length blade 10, the tip portion 11 may be movable with respect to the root portion 19 so as to controllably increase and/or decrease the length of the rotor blade 10, and in turn, respectively increase and decrease the swept area of the rotor blades 10. Any desirable drive system, such as a screw drive, a piston/cylinder, or a pulley/winch arrangement may be used to move the tip portion 11 with respect to the root portion 19. Such drive systems are described in U.S. Pat. No. 6,902,370, which is hereby incorporated by reference. The wind turbine 2 further includes a yaw drive and a yaw motor, and may include a pitch control system, not shown.

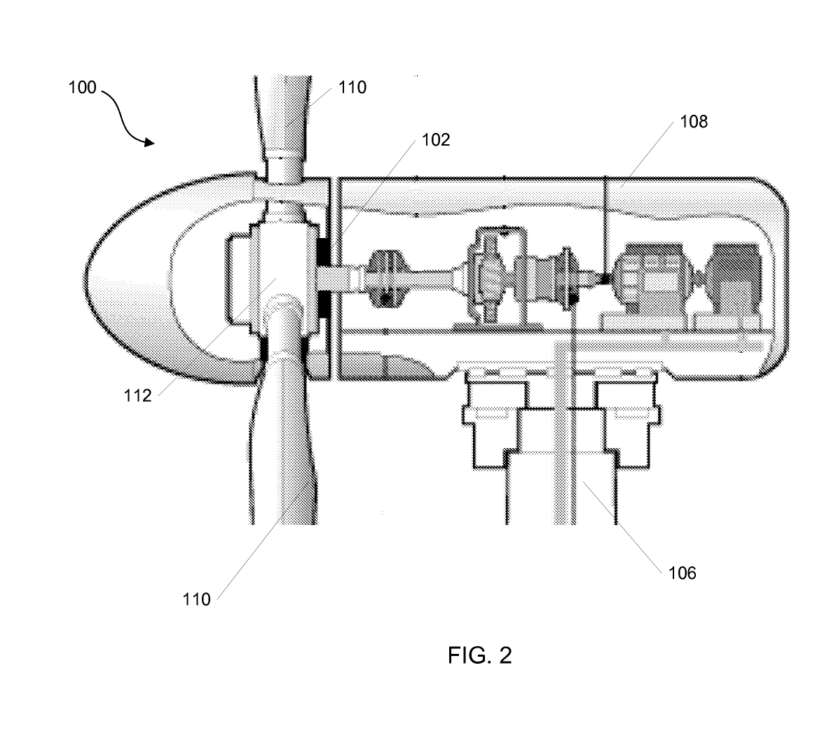

FIG. 2 illustrates one example partial cross sectional view of an example wind turbine 100 having a rotatable dry air supply 102. Similar to the wind turbine 2 of FIG. 1, wind turbine 100 may include a foundation (not shown in FIG. 2) with a tower 106 supporting a nacelle 108. As shown in FIG. 2, the nacelle may house various drive systems and components, as well as a gear box, generator, etc. The wind turbine 100 further includes a plurality of blades 110 connected to a rotatable hub 112. The wind turbine 100 may also include a rotatable dry air supply 102. The rotatable dry air supply 102 is shown schematically and may be connected to the hub 112 and may rotate with the hub 112, thereby providing dry air for purging one or more pressure sensing ports (not shown) arranged on the blades 110 continuously, during rotational operation of the turbine 100.

In some examples, the rotatable dry air supply 102 may be arranged between the nacelle 108 and the rotatable hub 112. In other examples, the rotatable dry air supply 102 may be mounted to a closeout plate (not shown in FIG. 2) arranged in a root of one of the turbine blades 110. In some examples, the closeout plate may be a round or circular plate formed of any suitable material, such as fiberglass, and may be positioned to reduce or prevent debris, tools, parts, personnel, etc. from falling into an open turbine blade interior. In some examples, the closeout plate may be ½ to ¾ inch thick and may connect to a flange in the root of the blade 100, such a via bolts, screws, or other fasteners. Tubing may be routed through the hub 112 to supply dry air from the rotatable dry air supply to the ports in one or more turbine blades 100.

In still other examples, the rotatable dry air supply 102 may be mounted in any location within the hub 112 or blade roots. For instance, the rotatable dry air supply 102 may be mounted within the hub 112 or blade root such that the rotatable dry air supply 102 does not interfere with other hub components, such as a pitch motor (not shown in FIG. 2). In some arrangements, this may include mounting the rotatable dry air supply 102 on or near an axis of hub rotation. At this location, centripetal acceleration have limited impact on removal of moisture from a moisture separator or, in some examples, may not assist in removal of moisture from a moisture separator, and a majority of the bulk moisture may be removed by a moisture trap, as will be discussed more fully below.

In still other arrangements, the rotatable dry air supply 102 may be mounted on an existing plate or frame, such as a pitch motor mounting plate, custom frame, and the like.

In some examples, the rotatable dry air supply 102 may be connected to the hub 112 using bolts, screws or other known fasteners. The rotatable dry air supply 102 may also include one or more tubes or hoses (not shown) extending outward from the rotatable dry air supply 102 to the one or more pressure sensing ports (not shown) arranged on the blades 110. These hoses or tubes may convey dry air for purging the ports, as will be discussed more fully below.

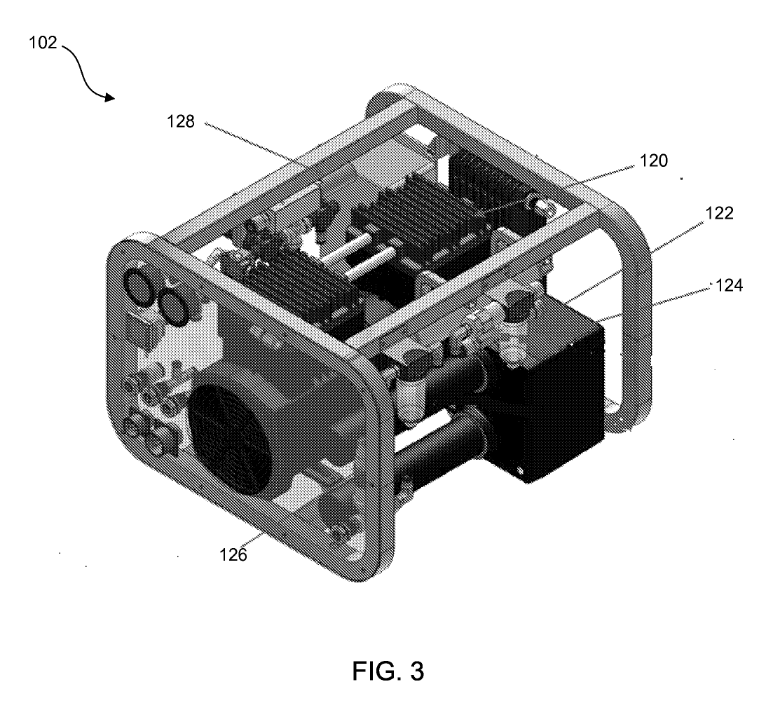

FIG. 3 illustrates one example rotatable dry air supply system 102 shown in isolation. The rotatable dry air supply 102 may including a casing (not shown in FIG. 3) to contain and/or protect the components of the dry air supply system 102. The casing may be formed of steel, aluminum, or other material suitable to protect the components of the system 102. The rotatable dry air supply 102 may include a compressor 120 configured to compress air to a high pressure for purging the pressure sending ports or orifices arranged on one or more wind turbine blades. As discussed above, high pressure air may be used to purge pressure sensing ports in order to remove moisture, ice, debris, etc. from the ports. The use of dry air aids in reducing or eliminating the introduction of additional moisture to the pressure sensing ports during the purging process. In some examples, the compressor may provide air compressed to between 90 and 150 psi. This high pressure air may then pass through a series of devices intended to aid in removing moisture from the air in order to reduce or prevent further moisture, ice, etc. buildup on or in the ports when the high pressure air is used to purge the ports.

The rotatable dry air supply 102 may further include a moisture separator 122 configured to provide a removal of at least a portion of the moisture contained in the compressed, high pressure air. The moisture separator 122 may be a conventional moisture separator as generally known in the art. In some examples, the moisture separator 122 may be a standard centrifugal/impingement separator with a pulse drain. The rotatable dry air supply 102 may further include a moisture trap (not shown in FIG. 3) that may aid in removing another portion of the moisture contained in the compressed air, as will be discussed more fully below. Further, the rotatable dry air supply 102 may include a dryer 124. In some examples, the dryer 124 may be a heatless dryer, such as a regenerative desiccant dryer. For example, the dryer 124 may include two desiccant columns. While one column is on-line (i.e., air flows from the compressor outlet through the column), the other column is off-line, and a small amount of dry air may flow through the off-line column to remove moisture that has been captured in the desiccant and exhaust it to the atmosphere.

The rotatable dry air supply 102 may also include a dew point sensor 128. In some examples, the dew point sensor 128 may aid in monitoring a health of the regenerative desiccant dryer 124. For instance, the dew point sensor 128 may provide an indication of when the on-line column should be taken off-line and regenerated and the off-line column put on-line. The dew point sensor 128 may also aid in establishing the efficacy of the moisture trap, e.g., during testing, operation, etc.

The compressed air from the compressor 120 having all or substantially all of the moisture removed therefrom may then be supplied to the one or more pressure sensing ports or orifices arranged on one or more blades (e.g., 110 in FIG. 2) of the wind turbine (e.g., 100 in FIG. 2). In some arrangements, the rotatable dry air supply system 102 may include one or more valves configured to control the flow of the high pressure, compressed air. For instance, the one or more pressure sensing ports or orifices may include one or more pressure sensors to sense pressure at various points along the length of the blade and to determine a pressure difference across different points along the blade. In some example wind turbines, the pressure differential may be used to adjust operation of the wind turbine. For instance, the measure pressure readings, and associated pressure differentials, may be used to adjust a length, pitch, etc. of one or more blades to optimize operation of the wind turbine. These pressure sensors may be damaged if exposed to the high pressure, compressed air, which may result in inaccurate readings and, thus, inefficient operation of the wind turbine. Accordingly, one or more valves, such as cut off valve 126 may be used to protect the sensor(s) from high pressure air during purging of the pressure sensing ports or orifices. For instance, the valve 126 may direct flow through the port but without contacting the sensor. The one or more valves, such as valve 126 may be, in some examples, pneumatically controlled.

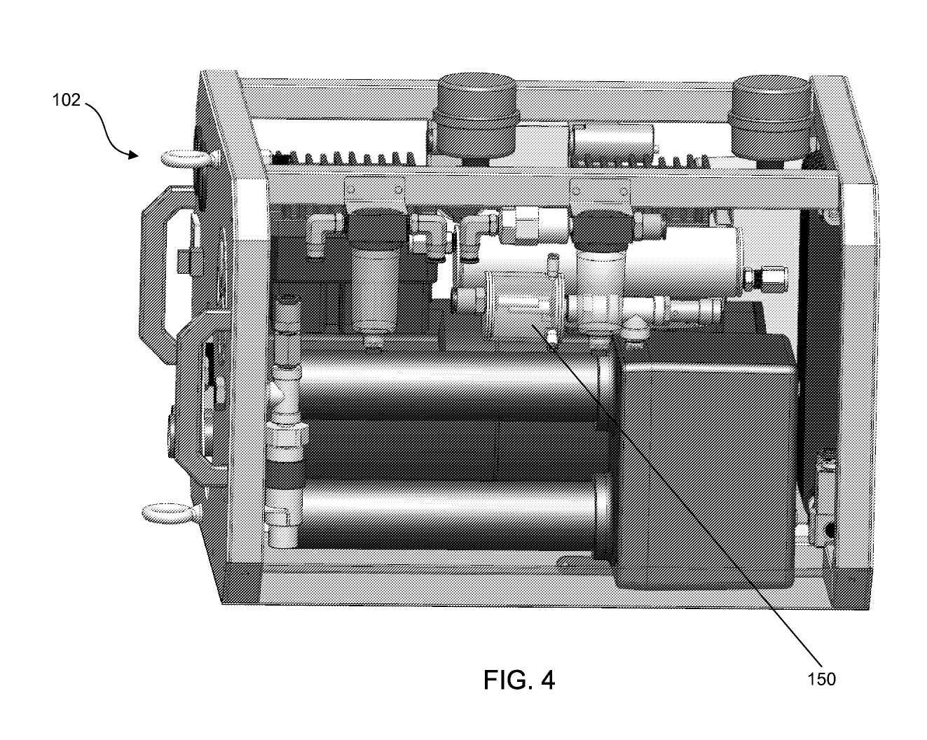

FIG. 4 is a side view of the rotatable dry air supply 102 of FIG. 3 with the moisture trap 150 shown. As discussed above, the moisture trap 150 may aid in removing moisture from the compressed air stream before it is used to purge the one or more pressure sensing ports or orifices. In some conventional dry air supply systems, gravity drain moisture removed by the moisture separator to remove it from the compressed air stream. For instance, bulk moisture removed in the moisture separator typically collects in a bowl in the moisture separator and is subsequently removed by gravity/pulse drain. However, collection of moisture in conventional systems would be difficult if not impossible if the dry air supply was rotatable, as the dry air supply system 102, as described herein, is. For instance, as the air supply rotates, a conventional system would not have drainage arranged to allow gravity to draw the moisture downward when the air supply is in different positions during rotation of the wind turbine. As the hub rotates, the bulk moisture in these conventional systems can be carried over into the air stream past the moisture separator. Accordingly, a moisture trap, such as trap 150 is used to trap moisture continuously (e.g., at every rotation) to remove moisture in the rotatable system described herein.

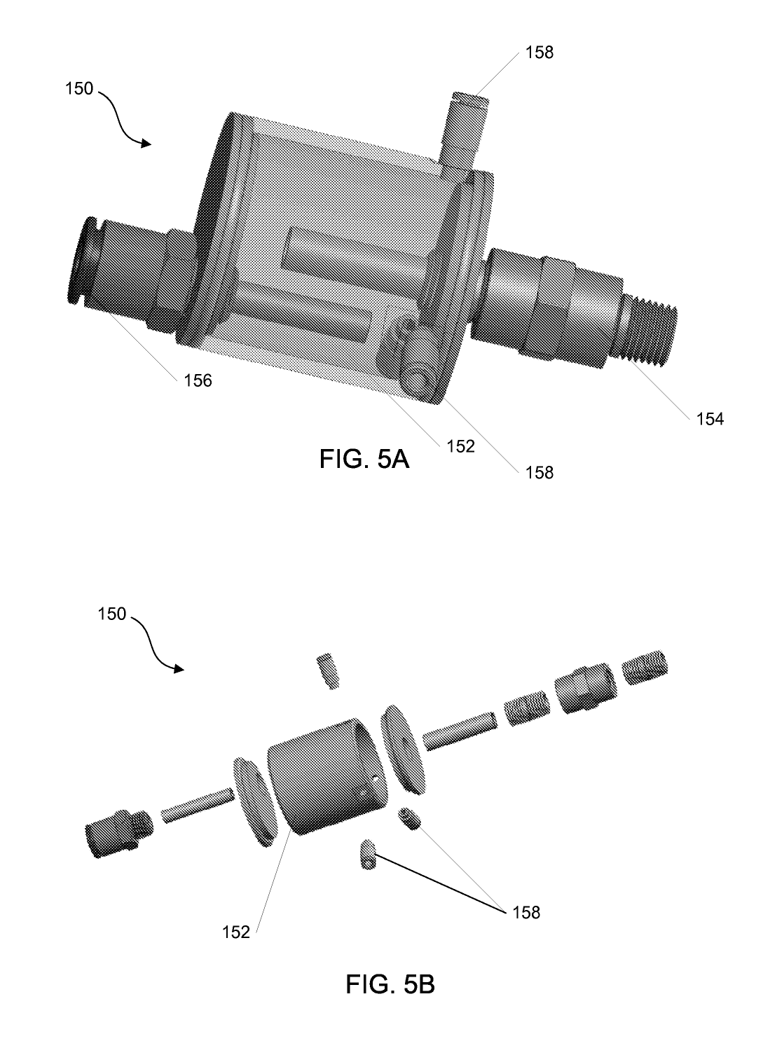

FIG. 5A shows the moisture trap 150 in isolation and FIG. 5B is an exploded view of the moisture trap 150. The trap casing 152 is illustrated as transparent in FIG. 5A to allow a view of the interior of the trap. However, the trap casing 152 can be transparent, translucent, opaque, etc. and can be formed of any suitable material. The moisture trap 150 may also include an inlet port 154 into which moist or semi-moist compressed air enters the trap 150, and an outlet port 156 through which compressed, less moist air exits the trap 150. In some examples, the inlet port 154 and outlet port 156 may be offset. As moist air enters the moisture trap 150, the moisture collects in the trap casing 152. In some instances, this moisture collected may include moisture carried over in the air stream from the moisture separator. In order to remove the trapped moisture in the trap casing 152, a plurality of outlet ports 158 are provided on the moisture trap 150.

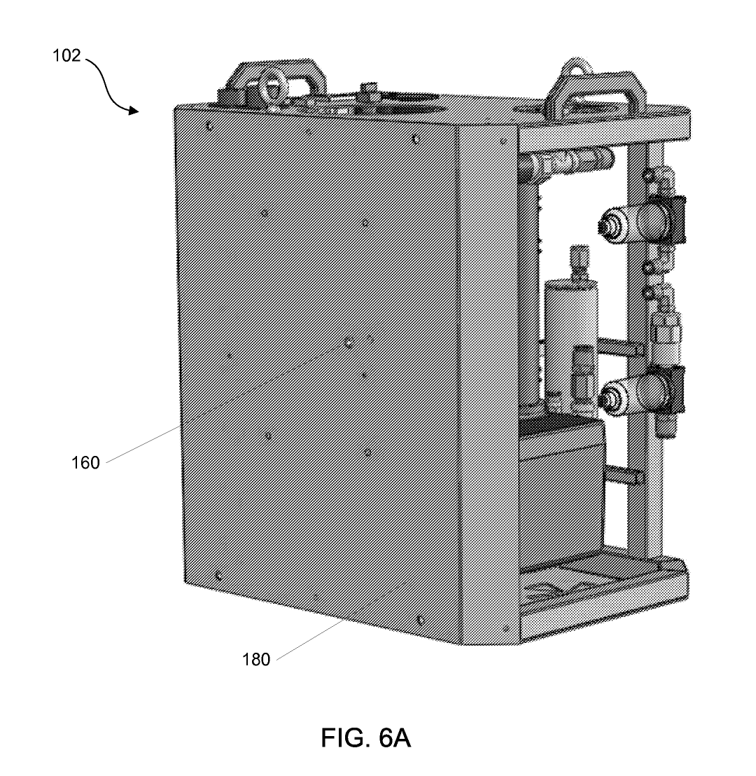

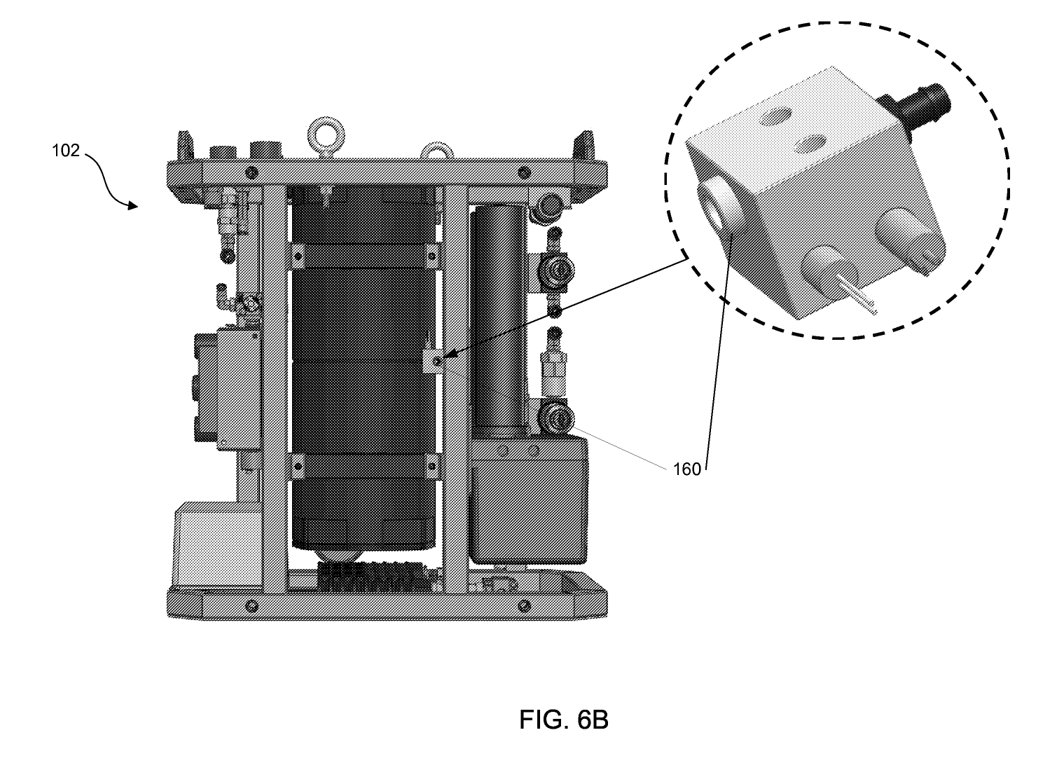

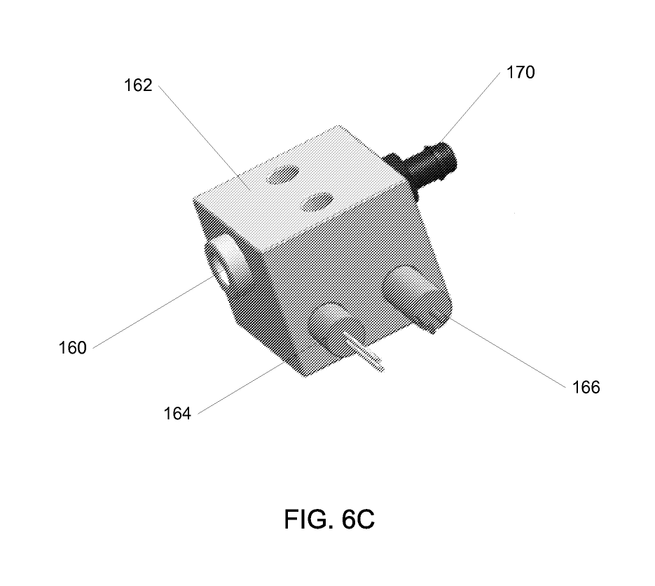

The outlet ports 158 are arranged at various positions around the trap casing 152 in order to collect and remove moisture as the dry air supply 102 rotates. That is, as the dry air supply 102 rotates, moisture within the trap casing 152 will also rotate and can exit through one of the plurality of outlet ports 158 depending upon the position of the dry air supply 102 in rotation. In some arrangements, when the compressor completes a cycle and turns off, an unloader valve may open to depressurize the lines within the dry air system. This may prevent the compressor from starting up under load. Additionally, this may empty or blow out the moisture trap (e.g., force moisture out of the outlet ports 158 and, in some cases out of the rotatable dry air supply system) because the depressurization path may run from the moisture trap to the moisture outlet (160 in FIGS. 6A-6C).

In some examples, the outlet ports 158 may be arranged equidistant around the casing 152 of the moisture trap 150. This arrangement may aid in continuous removal of moisture from the air stream at any position throughout 360° of rotation and may enable the dry air supply 102 to rotate with the turbine blades, thereby providing high pressure air for purging of pressure sensing ports continuously (e.g., throughout any position in the rotation of the turbine blades). Although three outlet ports 158 are shown, more outlet ports 158 may be used without departing from the invention.

In some examples, the outlet ports 158 may be connected, such as via tubing, to a moisture outlet of the dry air supply 102. FIGS. 6A and 6B illustrate example moisture outlet arrangements. FIG. 6A illustrates a dry air supply 102 with portions of the casing 180 removed. As discussed above, the casing may protect the components of the dry air supply 102 and may be formed of any suitable material including steel, aluminum, composites, etc. The dry air supply moisture outlet 160 extends through a first surface of the casing 180. In some examples, multiple moisture outlets 160 may be arranged on one or more surfaces of the casing 180.

FIG. 6B illustrates the dry air supply 102 with the portion of the casing 180 removed and illustrating a position of the moisture outlet 160. The moisture outlet 160 may, as discussed above, be connected to the plurality of moisture trap outlet ports 158, such as via tubing or hosing. In some examples, a manifold (not shown) may collect moisture from the multiple moisture trap outlet ports 158 for removal via the moisture outlet 160. The inset in FIG. 6B is an enlarged view of the moisture outlet 160 shown housed in a moisture outlet casing, as will be discussed more fully below. FIG. 6C is the inset portion of FIG. 6B providing a perspective view of the moisture outlet 160 and associated casing.

The moisture outlet 160 is illustrated in a moisture outlet casing or housing 162. In some examples, the moisture outlet 160 may be heated, in order to prevent or reduce freezing of the moisture as it exits the moisture outlet 160. For instance, the casing 162 may also contain a heater 164, as well as a thermostat 166 to regulate the temperature of the system. In some examples, multiple heaters may be used in order to provide a broad range of temperatures. The moisture outlet casing 162 may also include an inlet 170. The inlet may receive moisture, such as from the moisture trap outlet ports (158 in FIGS. 5A and 5B). As discussed above, in some examples, the moisture received from the moisture trap outlet ports 158 may collect in a manifold that collects moisture from the plurality of outlet ports 158 and channels it to the inlet 170 on the moisture outlet casing 162. The moisture may then exit through heated outlet port 160.

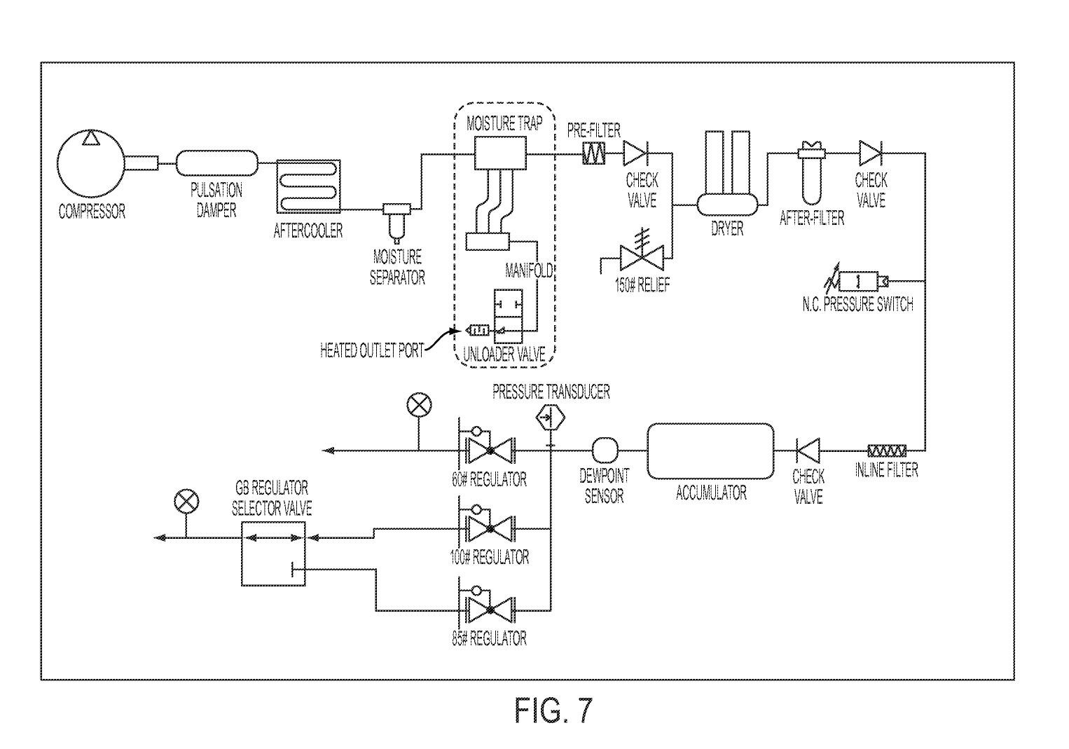

FIG. 7 is a schematic diagram of the rotatable dry air supply system described herein. The compressor (such as compressor 120 in FIG. 3) compresses the air entering the rotatable dry air supply system. Moisture is then removed from the compressed air stream via moisture separator (e.g., 122 in FIG. 3), moisture trap (e.g., 150 in FIG. 4) and dryer (e.g., 124 in FIG. 3). Similar to the arrangement discussed above with respect to FIGS. 6A-6C, the moisture collected in the moisture trap is transferred to a manifold and then exits via a heated moisture outlet (e.g., 160). The compressed, dry air may then be used to purge one or more pressure sensing outlets arranged on one or more blades of the turbine.

Although generally described in conjunction with a wind turbine, the above described system may be used with a variety of applications. For instance, the system and method may be implemented with helicopter rotors. Additionally or alternatively, the system and method described herein may be applied to non-aerodynamic applications.

The rotatable dry air supply system described herein may enable the use of dry air to purge one or more pressure sensing ports along a blade or airfoil. The use of a moisture trap having multiple outlet ports allows for continuous collection and removal of moisture from compressed air used for purging, throughout the entire rotation of the blade assembly. This continuous source of dry air for purging may improve efficiency and provide ease of access to dry, high pressure air for purging.

The disclosed invention is not limited by the above description and many variations of the above disclosed innovations will be evident to one skilled in the art.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A dry air supply, comprising:
a housing rotatably connected to a hub of a wind turbine, the hub including at least one wind turbine blade;
a compressor arranged within the rotatable housing;
a dryer arranged within the housing; and
a moisture trap arranged within the housing, the moisture trap being configured to trap moisture accumulating from compression of air in the compressor and during rotation of the housing, hub and at least one wind turbine blade.

2. The dry air supply of claim 1, wherein the moisture trap includes a plurality of outlet ports for purging moisture accumulated in the moisture trap, the outlet ports being arranged equidistant around a casing of the moisture trap.

3. The dry air supply of claim 2, wherein the moisture trap includes three outlet ports for purging moisture accumulated in the moisture trap.

4. The dry air supply of claim 2, wherein the moisture purged from the moisture trap exits the rotatable dry air supply via an outlet.

5. The dry air supply of claim 4, wherein the outlet is arranged in the housing.

6. The dry air supply of claim 4, wherein the outlet is heated.

7. The dry air supply of claim 1, wherein the dryer arranged within the housing is a heatless dryer.

8. The dry air supply of claim 7, wherein the dryer is a regenerative dessicant dryer.

9. The dry air supply of claim 1, wherein a plurality of pressure sensing ports arranged on the at least one wind turbine blade receives air from the dry air supply.

10. A wind turbine, comprising:
a foundation;
a tower connected to the foundation;
a hub connected to the tower;
a plurality of wind turbine blades connected to and arranged about the hub; and
a dry air supply connected to and arranged about the hub, the dry air supply being rotatable with the hub.

11. The wind turbine of claim 10, wherein the rotatable dry air supply includes a moisture trap having a plurality of outlet ports arranged around a casing of the moisture trap.

12. The wind turbine of claim 11, wherein the outlet ports are arranged equidistant around the casing of the moisture trap.

13. The wind turbine of claim 11, wherein moisture purged from the moisture trap exits the rotatable dry air supply via an outlet in a housing of the rotatable dry air supply.

14. The wind turbine of claim 13, wherein the outlet is heated.

15. The wind turbine of claim 10, wherein a plurality of pressure sensing ports arranged on the plurality of wind turbine blades receives air from the dry air supply.

16. A wind turbine, comprising:
a rotatable hub having a plurality of wind turbine blades connected to and arranged about the hub; and
a dry air supply connected to the hub, the dry air supply being rotatable with the hub and including:
a housing;
a compressor arranged within the housing; and
a moisture trap arranged within the housing, the moisture trap being configured to trap moisture accumulating during compression of air in the compressor and during rotation of the hub and rotatable dry air supply.

17. The wind turbine of claim 16, wherein the moisture trap includes a plurality of outlet ports arranged around a casing of the moisture trap.

18. The wind turbine of claim 17, wherein the outlet ports are arranged equidistant around the casing of the moisture trap.

19. The wind turbine of claim 17, wherein moisture purged from the moisture trap exits the rotatable dry air supply via an outlet in a housing of the rotatable dry air supply.

20. The wind turbine of claim 17, wherein the outlet is heated.

21. The wind turbine of claim 16, wherein the rotatable dry air supply further includes a dryer.

22. The wind turbine of claim 16, wherein a plurality of pressure sensing ports arranged on the plurality of wind turbine blades receives air from the dry air supply.
